(19) United States
(12) Patent Application Publication
(10) Pub. No.: US 2009/0100262 A1
(43) Pub. Date: Apr. 16, 2009

(54) APPARATUS AND METHOD FOR DETECTING DUPLICATION OF PORTABLE SUBSCRIBER STATION IN PORTABLE INTERNET SYSTEM

(75) Inventor: Sung Ho Yoo, Seoul (KR)

Correspondence Address: BLANK ROME LLP, WATERGATE, 600 NEW HAMPSHIRE AVENUE, N.W., WASHINGTON, DC, 20037, US

(73) Assignee: POSDATA CO., LTD.

(21) Appl. No.: 12/282,820

(22) PCT Filed: Mar. 14, 2007
(86) PCT No.: PCT/KR2007/001252

§ 371 Date: Sep. 12, 2008

(30) Foreign Application Priority Data
Mar. 15, 2006 (KR) 10-2006-0024121

(51) Int. Cl. H04L 9/00; H04M 1/66

(52) U.S. Cl. 713/155; 455/411; 713/168

(57) ABSTRACT

An apparatus and method for detecting duplication of a portable subscriber station (PSS) in a portable Internet system are provided. A master key of a PSS and a master key of an AAA server are identically updated whenever the PSS succeeds in authentication. It is possible to determine whether the PSS is duplicated or not by comparing the master key of the PSS with the master key of the AAA server during an authentication procedure. In addition, it is possible to find out whether duplication for the corresponding PSS is made by a user's own volition or by a third party by additionally performing an authentication procedure which requires an input of a password for a PSS which is doubted as duplicated.

### TECHNICAL FIELD

The present invention relates to an apparatus and method for detecting duplication of a portable subscriber station in a portable Internet system, and more particularly, to an apparatus and method for detecting duplication of a portable subscriber station in a portable Internet system in which illegal duplication of a portable subscriber station (PSS) can be detected even when a media access control (MAC) address, a master key, and a call history count of an original PSS are duplicated to the duplicated PSS.

### BACKGROUND ART

Since a mobile telecommunication system using a cellular method was developed in America at the end of 1970's, an advanced mobile phone service (AMPS), which is a first generation mobile telecommunication system, started to provide a voice call service. A second generation mobile telecommunication system was commercialized in the mid 1990's, and an International Mobile Telecommunication-2000 (IMT-2000), which is a third generation mobile telecommunication system that was developed to provide a wireless multimedia and high speed data service, was partially commercialized at the end of 1990's and is currently being operated.

Mobile telecommunication technology is currently in a transitional period moving from the third generation mobile telecommunication system to a fourth generation mobile telecommunication system, and research on portable Internet technology which can provide a higher speed data transmission service than the third generation mobile telecommunication system is being actively performed.

The portable Internet system satisfies a desire of a user who wants to be provided with a high speed internet service anytime, anywhere using a portable mobile station, and it is expected to be a promising future industry since its pervasive effect on the whole telecommunication industry is quite significant. Thus, international standardization on the portable Internet system is progressing centered on IEEE 802.16.

In mobile telecommunication systems including the portable Internet system, both a portable subscriber station (PSS) and a mobile telecommunication network retain the same secret key in order to prevent illegal use of a third party other than a legitimate user/device as shown in FIG. 1, and authentication for a portable subscriber station (PSS) is performed such that the mobile telecommunication network confirms whether the PSS is an original PSS or not using the secret key when a service is provided. Such a secret-based authentication method is described below in detail with reference to FIG. 1.

FIG. 1 is a diagram for explaining a method for detecting duplication of a PSS according to a conventional art. In FIG. 1, a mobile telecommunication network 12 comprises a radio access station (RAS), an access control router (ACR), and an authentication server.

As shown in FIG. 1, a PSS11 and the mobile telecommunication network 12 share and store an authentication key (A-key) 13 and an A-key′ 14 which are identical to each other before an authentication procedure is performed, and store a shared secret data (SSD) 15 and SSD′ 16 which are identical to each other through an updating procedure of SSD.

Then, when the PSS11 tries to access the mobile telecommunication network 12, it generates an authentication response (AUTHR) 18 using a random number (RAND) 17, which is sent from the mobile telecommunication network 12, SSD and other parameters, and transmits AUTHR 18 to the mobile telecommunication network 12.

The mobile telecommunication network 12 computes an authentication response AUTHR through the same AUTHR generating procedure using information about a subscriber terminal stored therein and compares the computed AUTHR to AUTHR18 sent from the PSS11 to check whether they are identical to each other or not.

At this time, the mobile telecommunication network 12 also compares a call history count COUNT sent from the PSS11 and a call history count stored in the mobile telecommunication network 12 to check whether they are identical to each other.

If AUTHR and COUNT sent from the PSS11 are identical to those of the mobile telecommunication network 12, the PSS11 is authenticated as legitimate.

That is, if the PSS11 succeeds in authentication, it is allowed to access telecommunication services, but if it fails, a management procedure set by a network operator is performed to analyze a cause of authentication failure and transmit the cause of the authentication failure to the PSS11.

However, the method for detecting duplication of the PSS using AUTHR and COUNT has a problem in that a traffic load between the PSS and the mobile telecommunication network is increased since AUTHRs and COUNTs are separately compared in the mobile telecommunication network.

In order to resolve the above problems, Korean Patent No. 281,566 discloses a method for reducing an authentication load in the mobile telecommunication system using a call history count COUNT to compute AUTHR.

However, the method of Korean Patent No. 281,566 has the following problems in that it is difficult to apply to the portable Internet system “as is” since duplication of the PSS is detected using just a call history count COUNT.

First, the portable Internet system allows several users to use one PSS, but authentication for a user is excluded since only authentication for the PSS is performed. Thus, when the A-key and the call history count COUNT are duplicated to a duplicated PSS, it is difficult to confirm whether the PSS is illegally duplicated or not.

Second, when the original PSS is illegally duplicated, it is difficult to find out whether duplication is performed by a user's own volition or by a malicious third party.

### DISCLOSURE OF INVENTION

### Technical Problem

The present invention is directed to an apparatus and method for detecting illegal duplication of a PSS in a portable Internet system in which a master key of the PSS and a master key of an authentication authorization and accounting (AAA) server are simultaneously updated whenever authentication for the PSS is successfully performed, so that illegal duplication of the PSS can be detected even when a media access control (MAC) address, a master key and a call history count of the original PSS are duplicated to the duplicated PSS.

The present invention is also directed to an apparatus and method for detecting duplication of a PSS in a portable Internet system in which an authentication procedure, which asks a user of the PSS which is possibly illegally duplicated to input a password, is performed so that it is possible to find out whether duplication is performed by a user's own volition or by a malicious third party.

### Technical Solution

According to an aspect of the present invention, a method for detecting duplication of a portable subscriber station (PSS) in a portable Internet system including an authentication authorization and accounting (AAA) server which performs authentication for the PSS and a radio access station (RAS) wirelessly connecting the PSS and the AAA server, comprises the steps of: (a) performing a first authentication, at the AAA server, using a master key of a connected PSS; (b) updating the master key of the connected PSS when the first authentication is successfully performed, and performing a second authentication using inherent information provided to an original PSS when the first authentication fails; and (c) checking a duplication possibility bit value when the second authentication is successfully performed, authenticating the connected PSS as legitimate when there is no duplication possibility bit value and updating the master key of the connected PSS after assigning a duplication possibility value, and determining the connected PSS as duplicated when there is a duplication possibility bit value or the second authentication fails.

According to another aspect of the present invention, a method for detecting duplication of a portable subscriber station (PSS) in a portable Internet system including an AAA server which performs authentication, the PSS including an original PSS and a duplicated PSS which store information including a MAC address, a master key, and a call count of the original PSS, comprises the steps of: (a) performing a first authentication, at the AAA server, using a master key of a connected PSS; (b) updating the master key of the connected PSS and allowing access of the connected PSS to a network when the first authentication is successfully performed, and performing a second authentication using inherent information provided to an original PSS when the first authentication fails; and (c) updating the master key of the connected PSS and allowing access of the connected PSS to the network when the second authentication is successfully performed, and determining the connected PSS as duplicated and rejecting access of the connected PSS to the network when the second authentication fails.

According to yet another aspect of the present invention, an apparatus for detecting duplication of a portable subscriber station (PSS) in a portable Internet system, comprises: a memory including an authentication table for storing a master key and a duplication possibility bit value for each PSS; a PSS duplication determining means for comparing the master key of the PSS connected through a radio access station (RAS) with the master key stored in the authentication table to determine whether the connected PSS is legitimate or not, and determining whether the connected PSS is duplicated or not using the duplication possibility bit value stored in the authentication table; a master key updating means for identically updating the master key of the connected PSS and the master key of the authentication table when the connected PSS is determined to be legitimate; and an authentication controller for performing the whole operation related to authentication and duplication determination for the connected PSS.

### ADVANTAGEOUS EFFECTS

As described above, the PSS duplication detecting apparatus and method according to the present invention have the following advantages.

First, it is possible to prevent the duplicated PSS from using portable Internet services in the portable Internet system, and it is possible to detect illegal duplication of the PSS even when the MAC address, the master key, and the call history count of the original PSS are duplicated to the duplicated PSS.

Also, if the original PSS is illegally duplicated, it is possible to find out whether duplication is illegally made by the user's own volition or by a malicious third party.

Further, the authentication method which does not require an input of a password is rapidly performed for the original PSS, and the authentication method which requires an input of a password is performed for the duplicated PSS, so that authentication can be efficiently performed.

Furthermore, since the duplication confirmation value is computed by the hash function and duplication is detected by verifying the duplication confirmation value, it can be realized without using additional devices or changing the protocol.

### BRIEF DESCRIPTION OF THE DRAWINGS

FIG. 1 is a diagram for explaining a method for detecting duplication of a portable subscriber station (PSS) according to a conventional art;

FIG. 2 is a schematic diagram illustrating a portable Internet system according to an exemplary embodiment of the present invention;

FIG. 3 shows a layer structure of the portable Internet system of FIG. 2;

FIGS. 4 to 9 are diagrams illustrating a basic concept of a method for detecting duplication of the PSS according to the exemplary embodiment of the present invention;

FIG. 10 is a flowchart illustrating flow of a media access control (MAC) message for the PSS duplication detecting method according to the present invention;

FIG. 11 shows a MAC message newly defined to detect duplication of the PSS according to the present invention;

FIG. 12 shows the method for computing the CCV_PSS using a hash function according to the exemplary embodiment of the present invention;

FIG. 13 shows an EAP-AKA and an EAP-MD5 shown in FIG. 10;

FIG. 14 is a flowchart illustrating a traffic connection setup of the PSS in the portable Internet system according to the exemplary embodiment of the present invention;

FIG. 15 is a detailed flowchart illustrating the PSS duplication detecting step P of FIG. 14;

FIG. 16 is a block diagram illustrating an apparatus for detecting illegal duplication of the PSS in the portable Internet system according to the exemplary embodiment of the present invention; and

FIG. 17 shows the authentication table of the memory according to the exemplary embodiment of the present invention.

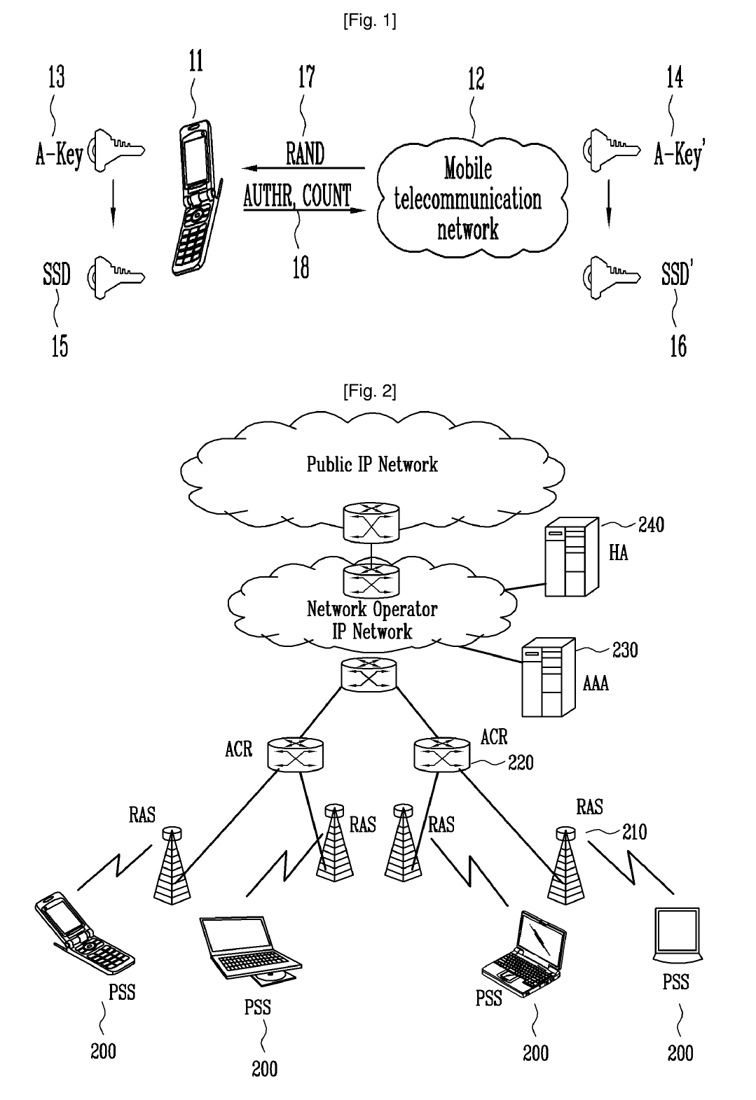

### DESCRIPTION OF MAJOR SYMBOLS IN THE ABOVE FIGURES

200: PSS
210: RAS
220: ACR
230: AAA server
240: HA
300: PSS duplication detecting apparatus
310: Message receiving means
320: Authentication controller
330: Memory
331: Authentication table
340: PSS duplication determining means
350: Authentication method selecting means
360: Master key updating means
370: PSS duplication notifying means
380: Message transmitting means

### MODE FOR THE INVENTION

Hereinafter, exemplary embodiments of the present invention will be described in detail. However, the present invention is not limited to the exemplary embodiments disclosed below, but can be implemented in various types. Therefore, the present exemplary embodiments are provided for complete disclosure of the present invention and to fully inform the scope of the present invention to those ordinarily skilled in the art.

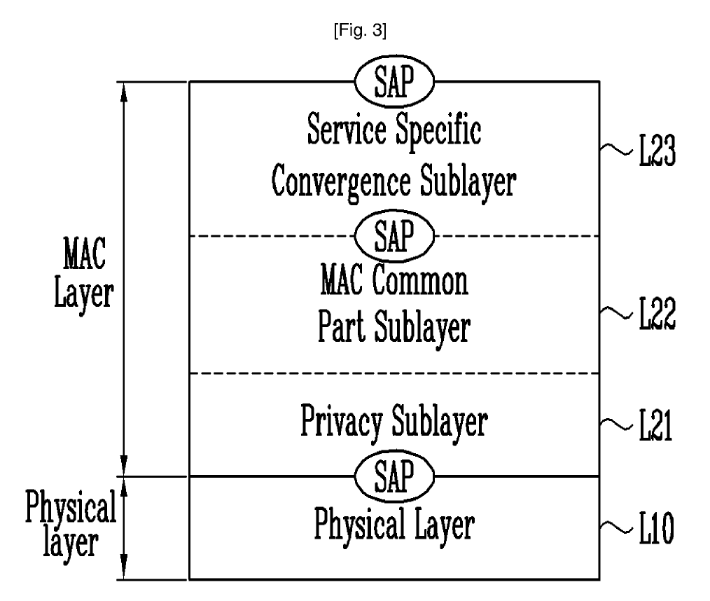

FIG. 2 is a schematic diagram illustrating a portable Internet system according to an exemplary embodiment of the present invention, and FIG. 3 shows a layer structure of the portable Internet system of FIG. 2.

As shown in FIG. 2, the portable Internet system comprises a portable subscriber station (PSS) 200, a radio access station (RAS) 210 for performing all control functions related to access of the PSS 200 and services, an access control router (ACR) 220 for controlling the RAS 210, an authentication authorization and accounting (AAA) server 230 connected to an IP network to perform authentication, authorization and accounting functions, and a home agent (HA) 240 for providing IP mobility through the IP network.

In order to make a high speed data service available even while the PSS 200 is moving, the PSS 200 and the RAS 210 perform communication in an orthogonal frequency division multiple access (OFDMA) method which is described below.

The OFDMA method is a multiplexing method which combines a frequency division multiplexing (FDM) method and a time division multiplexing (TDM) method. The OFDMA is robust to multipath fading and has a high data rate, and thus it has optimum transmission efficiency during high speed data transmission. Due to the above-described reasons, the OFDMA is currently being highlighted as a technology which can provide the PSS 200 with mobility in the portable Internet system.

Referring to FIG. 3, the layer structure of the portable Internet system according to IEEE 802.16 comprises a physical layer (L10) and a media access control (MAC) layer (L21, L22 and L23).

The physical layer L10 is responsible for wireless communication functions which are performed in a typical physical layer such as modulation/demodulation and coding.

The portable Internet system performs various functions in one MAC layer, unlike the wire line internet system which has functionally subdivided layers.

The MAC layer comprises a privacy sublayer L21, a MAC common part sublayer L22, and a service specific convergence sublayer L23.

The privacy sublayer L21 performs a device authentication and secret key exchange function and an encryption function. The privacy sublayer L21 performs only the device authentication, and user authentication is performed by an upper layer (not shown) of the MAC.

The MAC common part sublayer L22 is a core of the MAC layer and performs a system access function, a bandwidth allocating function, a traffic connection setting and maintaining function, and a QoS management function.

The service specific convergence sublayer L23 performs a payload header suppression function and a QoS mapping function in continuous data communication.

That is, the portable Internet system receives and transmits various messages to perform a request (REQ) function, a response (RSP) function, and an acknowledge (ACK) function for various operations using an MAC message having the layer structure of FIG. 3.

In the portable Internet system of FIG. 2, if all information including the A-key stored in the original PSS is duplicated to a duplicated PSS, the method for performing authentication for the PSS using just a call history count has a problem in that it cannot find out whether duplication is performed by a user's own volition or by a malicious third party.

In order to find out whether duplication is performed by a user's own volition or by a malicious third party, a master key is updated in both the PSS 200 and the AAA server 230 whenever authentication for the PSS 200 is successfully performed. Hereinafter, an apparatus and method for detecting illegal duplication of a PSS according to the exemplary embodiment of the present invention are described in detail.

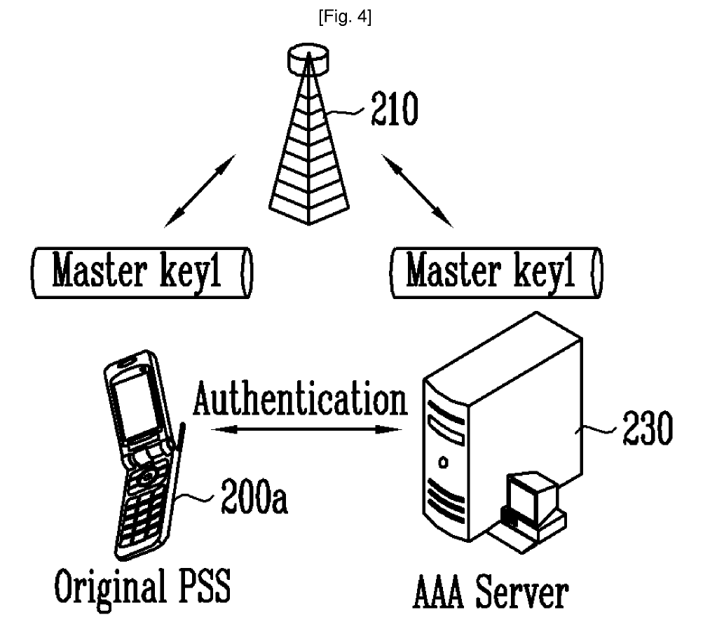

FIGS. 4 to 9 are diagrams illustrating a basic concept of a method for detecting duplication of the PSS according to the exemplary embodiment of the present invention.

(1) Authentication of Original PSS

As shown in FIG. 4, an original PSS 200a which enters a network through the RAS 210 performs an authentication procedure to be authenticated by the AAA server 230, so that the original PSS 200a and the AAA server 230 share a master key 1.

At this time, let us assume that the original PSS 200a is not duplicated.

Preferably, the original PSS 200 and the AAA server 230 perform the authentication procedure without asking for an input of a password for fast authentication.

(2) Duplication of Original PSS

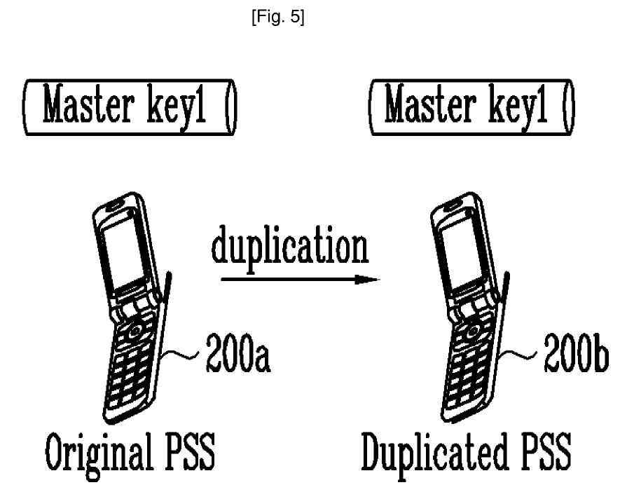

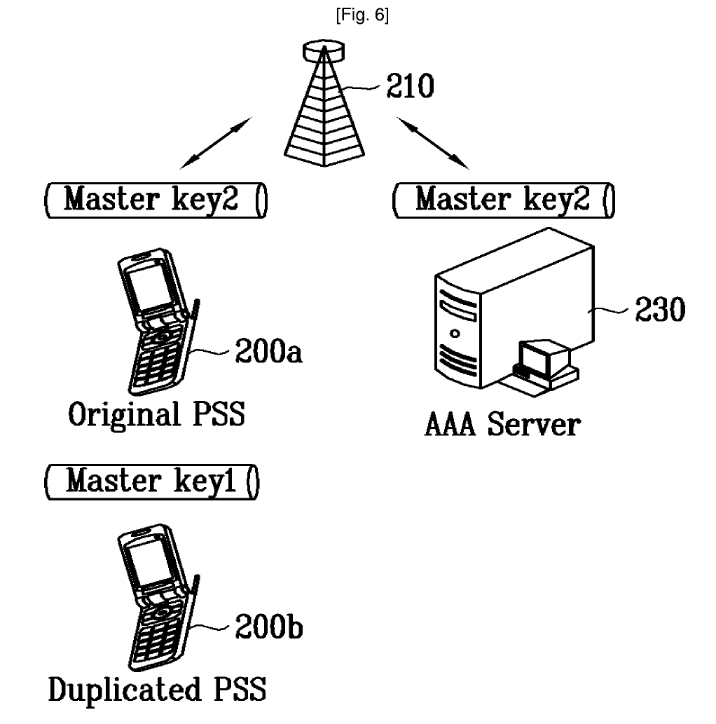

As shown in FIG. 5, duplication of the original PSS 200a happens. The duplicated PSS 200b of the original PSS 200a may be illegally made by a users own volition or by a malicious third party.

In this case, all information including a MAC address, a master key and a call history count stored in the original PSS 200a is duplicated to the duplicated PSS 200b.

(3) Authentication of Original PSS or Duplicated PSS

As shown in FIG. 6, the original PSS 200a enters the network through the RAS 210 before the duplicated PSS 200b to perform the authentication procedure and is successfully authenticated, so that the AAA server 230 generates a new master key 2 for the successfully authenticated original PSS 200a and transmits the new master key 2 to the original PSS 200a. As a result, the original PSS 200a and the AAA server 230 share the master key 2, whereas the duplicated PSS 200b retains the master key 1.

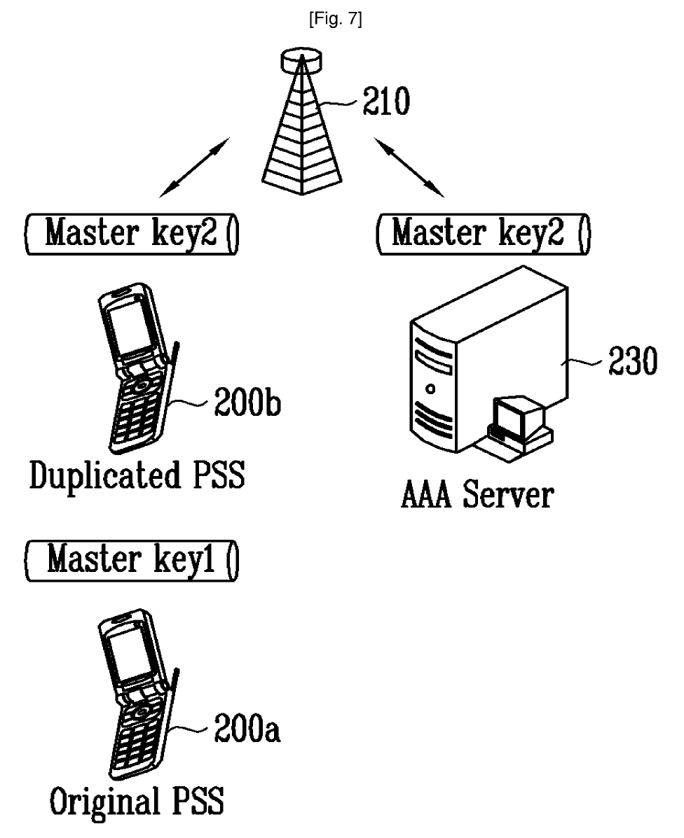

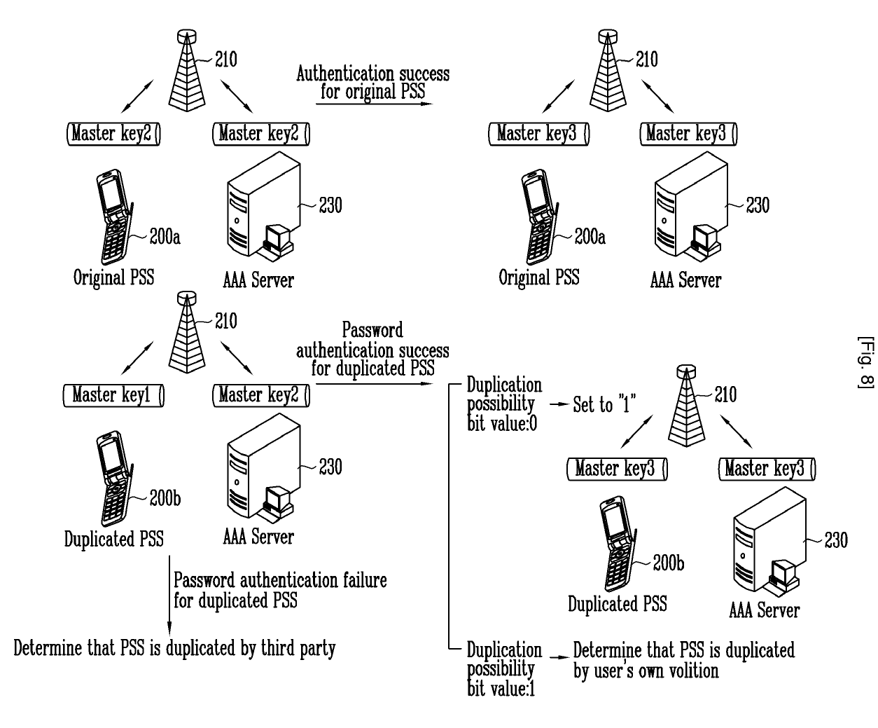

To the contrary, as shown in FIG. 7, the duplicated PSS 200b enters the network through the RAS 210 before the original PSS 200a to perform the authentication procedure, and the duplicated PSS 200b is successfully authenticated because it retains the master key 1. The AAA server 230 generates a new master key 2 for the successfully authenticated duplicated PSS 200b and transmits the new master key 2 to the duplicated PSS 200b. As a result, the duplicated PSS 200b and the AAA server 230 share the master key 2, whereas the original PSS 200a retains the master key 1.

(4) Determination of Duplication Type According to Authentication Success/Failure of Original PSS or Duplicated PSS

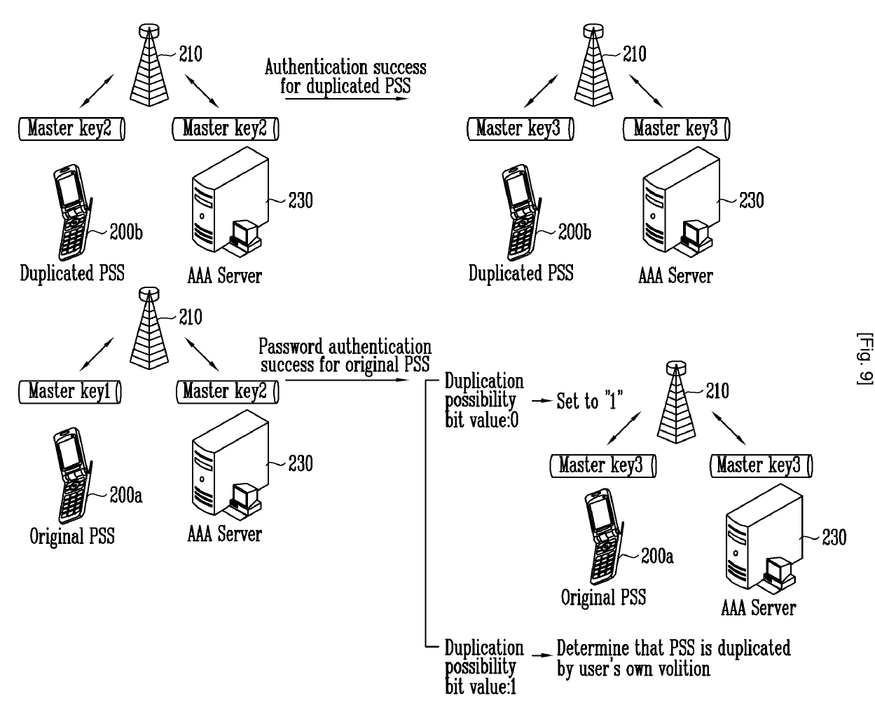

First, FIG. 8 illustrates a case where the original PSS 200a tries authentication in a state that the original PSS 200a retains the master key 2 but the duplicated PSS 200b retains the master key 1. In this case, since the original PSS 200a shares the master key 2 with the AAA server 230, authentication is successfully performed, and the AAA server 230 generates a new master key 3 and transmits it to the original PSS 200a to share.

Next, a case is shown where the duplicated PSS 200b tries authentication in a state that the original PSS 200a retains the master key 2 but the duplicated PSS 200b retains the master key 1. In this case, since the duplicated PSS 200b has the different master key from the master key of the AAA server 230, the AAA server 230 induces a user of the duplicated PSS 200b to perform a different authentication procedure. For example, the AAA server 230 may induce a user of the duplicated PSS 200b to input a password as the different authentication procedure.

In a case where the duplicated PSS 200b is made by a third party, a user of the duplicated PSS 200b finds it difficult to know a password, and so authentication fails. In this case, the AAA server 230 determines the duplicated PSS 200b as a PSS illegally duplicated by a malicious third party and so rejects authentication. As a result, it does not update a master key for the duplicated PSS 200b.

However, in a case where the duplicated PSS 200b of the original PSS 200a is made by a user's own volition, a user of the duplicated PSS 200b can know a password. Thus, in order to prevent the duplicated PSS 200b from being used, when password authentication is passed, the AAA server 230 checks a “duplication possibility” bit value of the corresponding PSS in an authentication table and sets it to “1” if it is “0”, in order to indicate that there is a duplication possibility. The AAA server 230 generates a new master key 3 and transmits it to the duplicated PSS 200b to share.

If the “duplication possibility” bit value is “1” and the duplicated PSS 200b has previously passed the password authentication, the AAA server 230 determines that the duplicated PSS 200b is illegally made by a user's own volition since only a PSS user knows a password. The AAA server 230 rejects authentication of the duplicated PSS 200b, and so the master key is not updated for the duplicated PSS 200b any further. As illustrated in FIG. 9, the duplicated PSS 200b tries authentication in a state that the duplicated PSS 200b retains the master key 2 and the original PSS 200a retains the master key 1 (see FIG. 7). In this case, since the duplicated PSS 200b and the AAA server 230 share the same master key 2, authentication is successfully performed, and the AAA server 230 generates a new master key 3 and transmits it to the duplicated PSS 200b to share.

Next, a case is described where the original PSS 200a tries authentication in a state that the duplicated PSS 200b retains the master key 2 and the original PSS 200a retains the master key 1. In this case, since the original PSS 200a has a different master key from the master key of the AAA server 230, the AAA server 230 induces a user of the original PSS 200a to perform a different authentication procedure. For example, the AAA server 230 may induce a user of the original PSS 200a to input a password as the different authentication procedure.

In this case, a user of the original PSS 200a can know a password and thus can pass a password authentication. The AAA server 230 checks a “duplication possibility” bit value of the corresponding PSS in the authentication table and sets it to “1” if it is “0” in order to indicate that there is a duplication possibility. The AAA server 230 generates a new master key 3 and transmits it to the original PSS 200a to share.

If the “duplication possibility” bit value is “1” and the original PSS 200a previously passed the password authentication, the AAA server 230 determines that the original PSS 200a is illegally duplicated by a user's own volition since only a PSS user knows a password. The AAA server 230 rejects authentication of the original PSS 200a, and so the master key is not updated for the original PSS 200a any further.

As described above, since the master key of the PSS and the master key of the AAA server 230 are updated whenever the PSS succeeds in network authentication of the PSS, it is possible to find out whether the PSS is the duplicated PSS or not by comparing the master key of the PSS to the master key of the AAA server 230.

That is, even though the duplicated PSS stores all information including a MAC address, a master key, and the A-key of the original PSS, if one of the original PSS and the duplicated PSS successfully performs authentication, the master key of the AAA server 230 is updated. Thereafter, when the other accesses to request authentication using the previous master key, the AAA server 230 recognizes a difference between the master keys and doubts that the PSS of the corresponding MAC address is duplicated.

At this time, for the PSS in doubt, the AAA server 230 performs the password authentication procedure so that a user is required to input a password. If password authentication fails, the AAA server 230 determines that the PSS is maliciously duplicated by a third party.

If the PSS in doubt succeeds in password authentication, the AAA server 230 determines that the PSS is illegally duplicated by a user's own volition, since only the user knows a password.

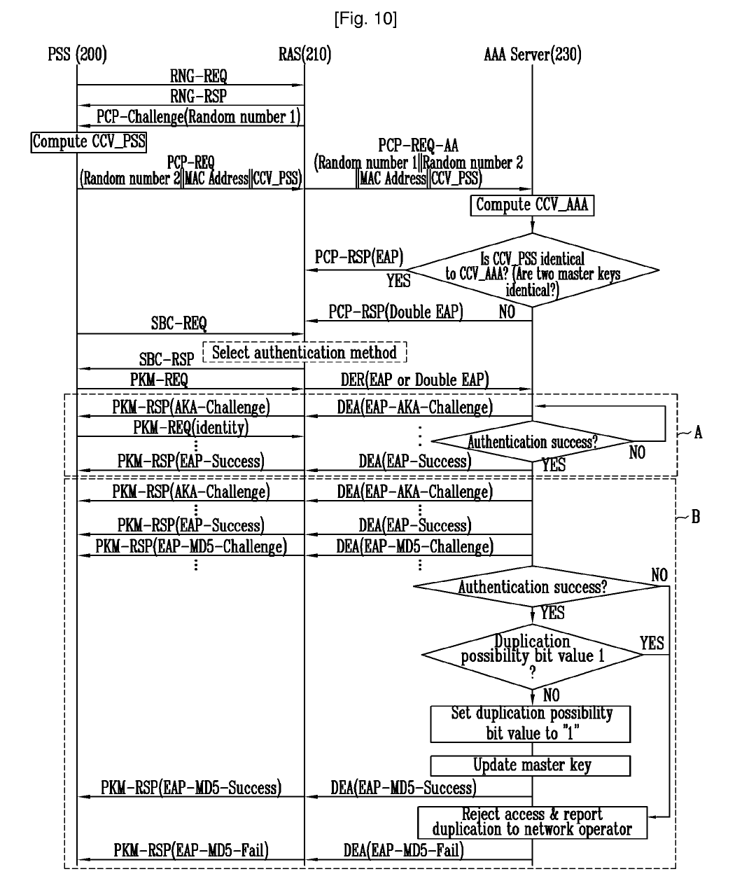

Hereinafter, the PSS duplication detecting method according to the present invention is described in more detail with reference to FIGS. 10 to 15.

FIG. 10 is a flowchart illustrating flow of a MAC message for the PSS duplication detecting method according to the present invention.

For ease of description, let us denote a random number 1 generated in the RAS 210 as RAND_RAS, a random number 2 generated in the PSS 200 as RAND_PSS, a master key retained in the PSS 200 as M1, a duplication confirmation value 1 computed in the PSS 200 as CCV_PSS, a master key retained in the AAA server 230 as M1′, and a duplication confirmation value2 computed in the AAA server 230 as CCV_AAA.

As shown in FIG. 10, the PSS duplication detecting method according to the present invention is performed after a ranging procedure of the PSS 200 and the RAS 210.

First, when the ranging procedure is completed, the RAS 210 randomly generates the RAND_RAS for determination on duplication of the PSS 200, inserts it into a PSS counterfeiting protection (PCP)-challenge message and transmits it to the PSS 200.

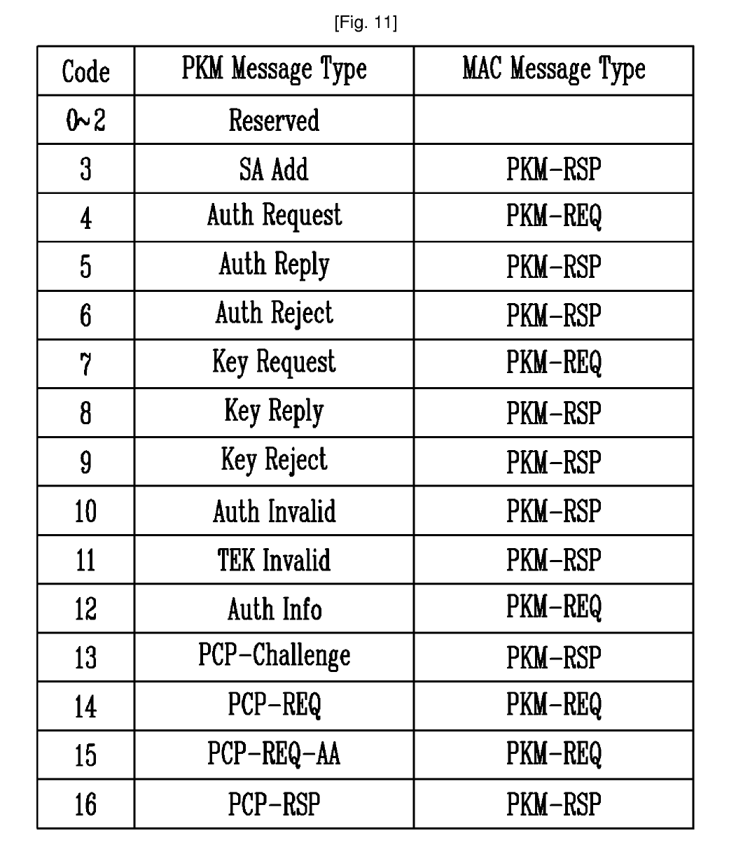

The PCP-challenge message, and a PCP-REQ message, PCP-REQ-AA message and PCP-RSP message which will be described later are MAC message newly defined in this specification to detect duplication of the PSS. These MAC messages are described below with reference to FIG. 11.

FIG. 11 shows the MAC message newly defined to detect duplication of the PSS according to the present invention.

Referring to FIG. 11, among the MAC messages according to IEEE 802.16, 10 types are defined as conventional PKM messages, which are codes 3 to 12.

That is, in the exemplary embodiment of the present invention, new PKM messages for detecting duplication of the PSS which are codes 13 to 16 are added to the conventional PKM message according to IEEE 802.16.

Here, a PKM message of a code 13 is a “PCP-Challenge” which is a PSS counterfeiting protection request message, PKM message of codes 14 and 15 are a “PCP-REQ” and a “PCP-REQ-AA”, which are CCV_PSS verifying request messages, and a PKM message of a code 16 is a “PCP-RSP” which is a CCV_PSS response message.

The types of PKM messages used for detecting duplication of the PSS described above are defined for description of the exemplary embodiment of the present invention, and they are not used to define a meaning or restrict the present invention's scope. Thus, a term, a code value and a message type can be varied appropriately according to a network operator's policy.

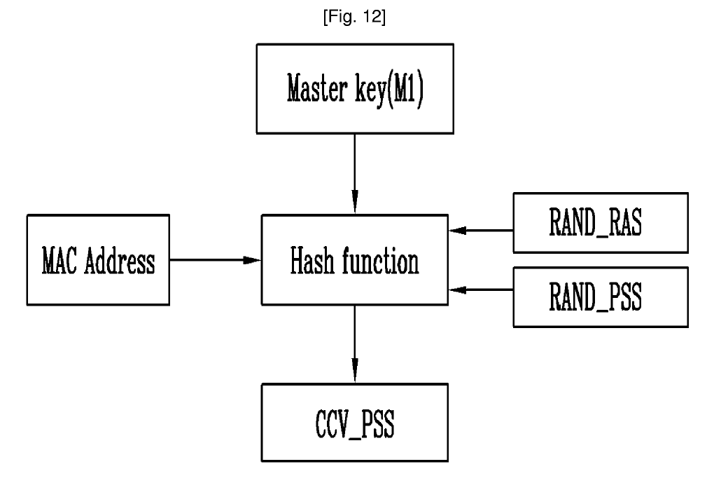

Referring again to FIG. 10, the PSS 200 inputs the RAND_RAS contained in the PCP-Challenge message received from the RAS 210, the RAND_PSS randomly generated therein, the master key M1 stored therein, and the MAC address to a hash function to compute the CCV_PSS, and inserts RAND_PSS, the MAC address and the CCV_PSS into the PCP-REQ message and transmits it to the RAS 210. A method for computing the CCV_PSS using a hash function is described in detail with reference to FIG. 12.

FIG. 12 shows the method for computing the CCV_PSS using a hash function according to the exemplary embodiment of the present invention. As shown in the following Equation 1, CCV_PSS is calculated using the hash function. The RAND_RAS randomly generated in the RAS 210, the RAND_PSS randomly generated in the PSS 200, the master key M1 stored in the PSS 200, and the MAC address of the PSS 200 are used as input values to the hash function.

CCV_PSS=SHA1{M1 I RAND_RAS I RAND_PSS I MAC address}; [Equation 1]

wherein SHA1 is a hash function for reducing data of long length to data of a pre-determined length and is used for increasing efficiency of a digital signature and checking integrity of important information. The SHA1 is a function which is usually used as an IPSec which is a representative internet security protocol, an SMIME which is a safe e-mail security standard, a TSL for providing end-to-end security, and an encryption function in an authentication-based security protocol.

Referring again to FIG. 10, the RAS 210 inserts the RAND_RAS generated therein together with the RAND_PSS, the MAC address and the CCV_PSS into the PCP-REQ-AA message and transmits it to the AAA server 230.

That is, the PCP-REQ-AA message contains the RAND_RAS, the RAND_PSS, the MAC address, and the CCV_PSS.

Then, the AAA server 230 inputs the RAND_RAS, the RAND_PSS, the master key M1′ retained therein, and the MAC address of the PSS 200 to a hash function to compute a CCV_AAA for determining whether the PSS 200 is duplicated or not. A method for computing the CCV_AAA can be easily understood with reference to Equation 1, and thus description thereof is omitted.

The AAA server 230 compares the CCV_PSS computed in the PSS 200 to the CCV_AAA computed therein.

That is, if the PSS 200 and the AAA server 230 have the same master key, the CCV_PSS computed in the PSS 200 is identical to the CCV_AAA computed in the AAA server 230, and thus the AAA server 230 can verify the CCV_PSS using the master key M1 retained therein to check whether the PSS 200 is an original PSS or illegally a duplicated PSS.

If the CCV_PSS of the PSS 200 is identical to the CCV_AAA of the AAA server 230, that is, it is determined that the master key of the PSS 200 is identical to the master key of the AAA server 230, the AAA server 230 transmits the PCP-RSP(EAP) message for requesting an EAP-AKA authentication method in which a password is not needed to be inputted to the RAS 210.

However, if the CCV_PSS of the PSS 200 is not identical to the CCV_AAA of the AAA server 230, that is, it is determined that the master key of the PSS 200 is not identical to the master key of the AAA server 230, the AAA server 230 determines that the PSS 200 is illegally duplicated and thus transmits the PCP-RSP (Double EAP) for requesting an EAP-MD5 authentication method in which a password is needed to be inputted to the RAS 210.

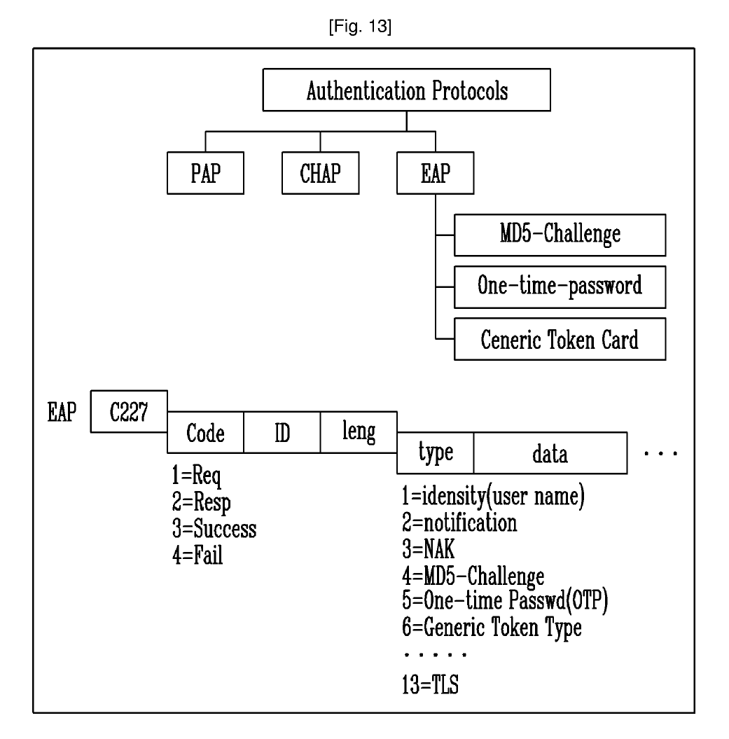

The EAP-AKA and the EAP-MD5 are authentication methods which can be used in the portable Internet system, and for easy understanding, the EAP-AKA and the EAP-MD5 are described below with reference to FIG. 13.

FIG. 13 shows the EAP-AKA and the EAP-MD5 shown in FIG. 10.

Referring to FIG. 13, the portable Internet system supports an extensible authentication protocol (EAP) authentication method which can accommodate various authentication protocols for providing a roaming service between networks of different types. In the EAP, since an authentication algorithm to be actually applied is determined by a Type field, the RAS and the ACR just transmit an EAP payload without considering the authentication algorithm, so that security and extensibility are reinforced.

That is, the EAP is a protocol which does not perform an actual authentication but encapsulates and transmits a method for actually performing authentication such as a message digest number 5 (MD5), a transport layer security (TLS), a secure remote password (SRP), and a tunneled TLS (TTLS).

In addition to the EAP-MD5, the EAP-TLS, the EAP-SRP, and the EAP-TTLS, a USIM card-based EAP-AKA authentication method was developed to apply a mutual roaming interworking function. The USIM card-based EAP-AKA authentication method is an authentication method which requests an identity of a user through an EAP-Request/AKA-identity message, and the USIM card of the PSS transmits its identity through the EAP-Request/AKA-identity message. The USIM card of the PSS verifies a message authentication code (MAC) value contained in a message transmitted from the AAA server 230 and confirms the resultant value if the verification result is successful. The AAA server 230 compares the received resultant value to a resultant value retained therein and allows access to the network if the two resultant values are identical.

The EAP-MD5 is an authentication method in which the AAA server 230 transmits a notification message for notifying the PSS of a start of the EAP-MD5 to ask a user to directly input a user ID and a password, the PSS hashes the user ID and the password using the MD5 and transmits the MD5-hashed value to the AAA server 230, and the AAA server 230 compares a hashed value previously stored therein to the MD5-hashed value and transmits a message for allowing the PSS to access the network if the two hashed values are identical.

That is, if the PSS 200 is determined as an original PSS, the AAA server 230 transmits the PCP-RSP(EAP) message for requesting the EAP-AKA authentication method in which the password does not need to be input to the RAS 210 so that the EAP-AKA authentication method can be selected when an authentication method is selected during a subscriber station basic capability (SBC) negotiation procedure, which will be described in detail, whereby fast authentication can be performed for the original PSS without requiring an input of the password.

However, if the PSS 200 is determined to be an illegally duplicated PSS, the AAA server 230 transmits the PCP-RSP (Double EAP) message for requesting both the EAP-AKA authentication method and the EAP-MD5 authentication method which requires an input of the password to the RAS 210 so that the double EAP authentication method which requires an input of the password can be selected when the authentication method is selected during the SBC negotiation procedure. Thus, it is possible to find out whether the PSS 200 is illegally duplicated by a user or a malicious third party by the password authentication procedure.

Authentication method information contained in the PCP-RSP(EAP) message or the PCP-RSP(Double EAP) message is temporarily stored in the RAS 210 and then is used to select the authentication method during the SBC negotiation procedure.

Referring again to FIG. 10, when the authentication method is selected, the SBC negotiation procedure including an authentication mode negotiation procedure is performed for authentication of the PSS 200.

First, the PSS 200 transmits a SBC-Request message to the RAS 210 for basic capability negotiation, i.e., negotiation for selecting an authentication mode.

At this time, parameters related to a supportable authentication mode are contained in the SBC-Request message for authentication mode selection. Such parameters include a bandwidth allocation support parameter for negotiation for bandwidth ability of a physical layer and an authorization policy support parameter for authentication mode negotiation.

The RAS 210 which has received the SBC-Request message from the PSS 200 performs a basic capability negotiation previously defined in a privacy standard of IEEE 802.16 for authentication of the PSS 200 and selects one of supportable authentication modes using the authentication mode negotiation parameters contained in the SBC-Request message. At this time, the RAS 210 selects the authorization policy support parameter as the EAP-AKA authentication method when the PCP-RSP(EAP) message is received from the AAA server 230, and the RAS 210 selects the authorization policy support parameter as the Double EAP authentication method, in which the EAP-MD5 authentication method which requires a user to input a password as well as the EAP-AKA authentication method is performed, when the PCPRSP (Double EAP) message is received from the AAA server 230.

The RAS 210 transmits the basic capability negotiation result including an authentication mode to the PSS 200 through the SBC-Reply message.

When negotiations for various basic capabilities including an authentication mode are completed as described above, the PSS 200 and the RAS 210 perform authentication according to the authentication method selected by the above-described method, i.e., the authentication method requested by the AAA server 230.

If the EAP-AKA authentication method is selected by the basic capability negotiation procedure, the PSS 200 and the RAS 210 perform the EAP-AKA authentication procedure corresponding to a part “A” of FIG. 10. The EAP-AKA authentication procedure is disclosed in the privacy standard of IEEE 802.16, and thus description thereof is omitted.

When the PSS 200 is successfully authenticated by the EAP-AKA authentication procedure, the AAA server 230 determines that the PSS 200 is an original PSS, updates the master key for the corresponding PSS 200 and transmits the master key to the corresponding PSS 200 through the RAS 210.

When the authentication procedure and the master key updating procedure described above are completed, the PSS 200 is allowed to access the network.

Meanwhile, if the Double EAP authentication method is selected by the basic capability negotiation procedure, the PSS 200 and the RAS 210 perform a Double EAP authentication procedure corresponding to a part B of FIG. 10.

That is, the PSS 200 and the RAS 210 perform the authentication procedure of the EAP-MD5 which requires a user to input a password after the EAP-AKA authentication procedure. The Double EAP authentication procedure is disclosed in the privacy standard of IEE 802.16, and thus description thereof is omitted.

When the EAP-MD5 authentication procedure is performed, the user may make a mistake in inputting a password, and thus the user is preferably allowed to reinput the password up to a predetermined number of times (e.g., three times).

If the PSS 200 which is doubted as illegally duplicated succeeds in the password authentication according to the Double EAP authentication procedure, the AAA server 230 determines whether the duplication possibility bit value of the corresponding PSS 200 is “1” or not in the authentication table in order to check whether the corresponding PSS 200 has previously succeeded in the password authentication or not.

Here, the duplication possibility bit value checks a duplication possibility of the PSS, and it is set to “0” when there is no case where the corresponding PSS is determined to be duplicated, i.e., there is no duplication possibility, and to “1” when the PSS which is doubted as illegally duplicated succeeds in the password authentication.

If the duplication possibility bit value is “0”, that is, there is no case where the corresponding PSS is determined to be illegally duplicated, the AAA server 230 sets the publication possibility bit value of the corresponding PSS to “1” to indicate that there is a possibility that the corresponding PSS can be duplicated, updates the master key for the corresponding PSS and transmits it to the corresponding PSS through the RAS 210.

If the duplication possibility bit value is “1”, that is, the corresponding PSS has previously succeeded in the password authentication, the AAA server 230 determines that the corresponding PSS 200 is illegally duplicated by the user's own volition since a person who knows the password is only the user, and thus it rejects access of the corresponding PSS to the network and reports to the network operator the fact that the corresponding PSS is duplicated.

If the PSS 200 which is doubted as illegally duplicated fails in the password authentication, the AAA server 230 determines that the corresponding PSS 200 is maliciously duplicated by a third party and rejects access of the corresponding PSS 200 to the network while reporting it to the network operator so that the master key for the duplicated PSS cannot be updated.

As described above, according to the PSS duplication detecting method of the present invention, since the master keys of the PSS 200 and the AAA server 230 are simultaneously updated whenever the PSS 200 succeeds in authentication, checking whether the corresponding PSS is a duplicated PSS or not by comparing the master key of the PSS 200 to the master key of the AAA server 230 can be easily performed.

Also, according to the PSS duplication detecting method of the present invention, it is possible to check whether the PSS is illegally duplicated by the user or a malicious third party since the authentication procedure which requires the user of the PSS which is doubted as duplicated to input the password is additionally performed.

Hereinafter, the PSS duplication detecting method will be described below in more detail with reference to the attached drawings.

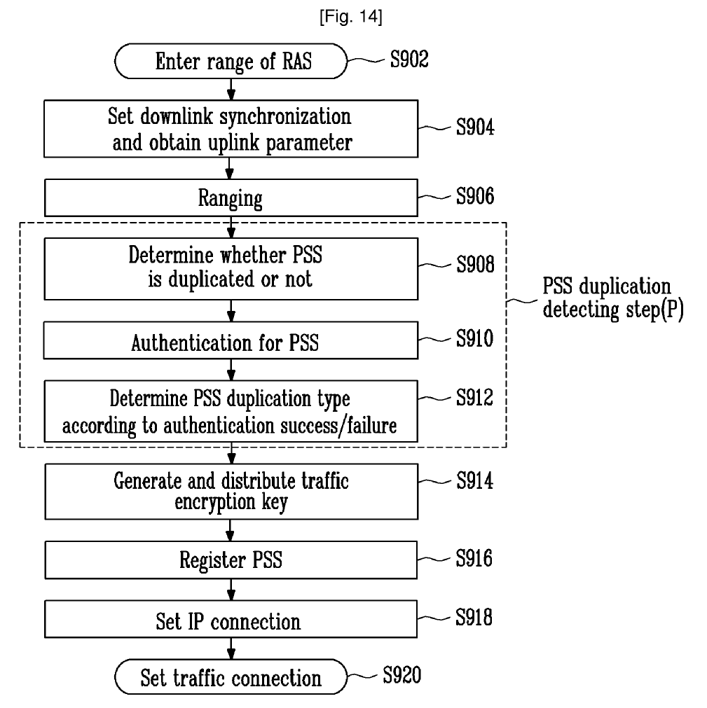

FIG. 14 is a flowchart illustrating a traffic connection setup of the PSS in the portable Internet system according to the exemplary embodiment of the present invention.

Referring to FIG. 14, when the PSS 200 enters a region of the RAS 210 (S902), the PSS 200 sets downlink synchronization with the RAS 210 and obtains uplink parameters (S904). For example, the parameter may include a channel descriptor message according to characteristics of a physical layer (e.g., signal to noise ratio(SNR)).

Then, the PSS 200 and the RAS 210 perform the ranging procedure (S906). Here, “ranging” is performed to correct timing, power and frequency information between the PSS 200 and the RAS 210 to be matched, and an initial ranging procedure is performed at the initial stage, and then a periodic ranging procedure using a CDMA code is performed.

When the ranging procedure is completed, it is determined whether the PSS 200 is a duplicated PSS or not (S908). At this time, as shown in FIG. 14, the authentication method selecting procedure according to the SBC negotiation and the PSS duplication determination result is also performed.

Authentication for the PSS 200 is performed according to the authentication method selected in the PSS duplication determining step S908 (S910), and the duplication type is determined according to success or failure of the authentication (S912).

For ease of description, the PSS duplication determining step S908, the PSS authenticating step S910, and the PSS duplication type determining step S912 are referred to as a PSS duplication detecting step P. The PSS duplication detecting step P is described below in more detail with reference to FIG. 14.

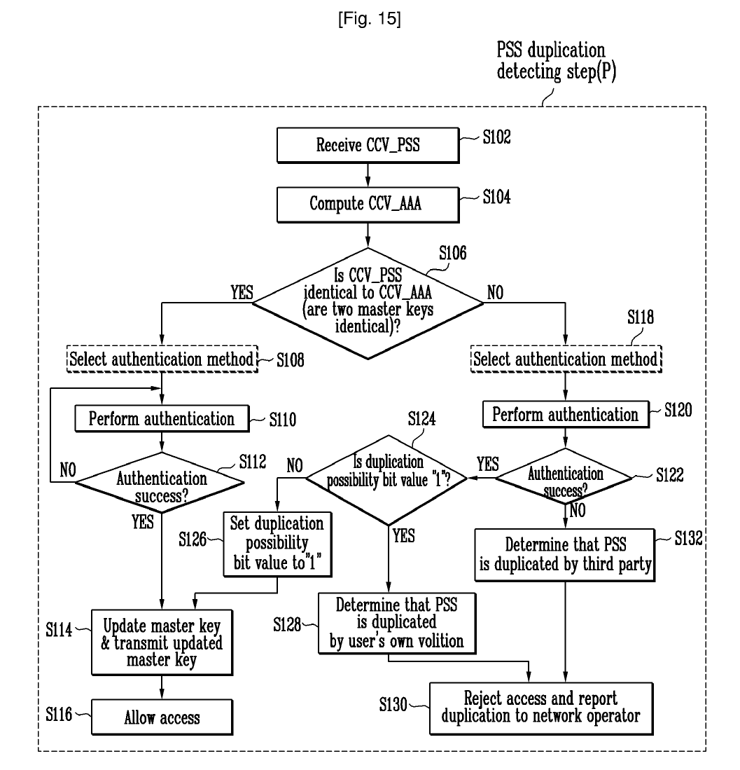

FIG. 15 is a detailed flowchart illustrating the PSS duplication detecting step P of FIG. 14.

First, the AAA server 230 receives the CCV_PSS of the PSS 200 through the PCP-REQ-AA message transmitted from the RAS 210 (S102). The PCP-REQ-AA message contains the RAND_RAS, the RAND_PSS and the MAC address of the PSS 200 in addition to the CCV_PSS of the PSS 200.

The AAA server 230 inputs at least one of the RAND_RAS, the RAND_PSS, the master key M1′, and the MAC address of the PSS 200 to the hash function to compute the CCV_AAA for determining whether the PSS 200 is duplicated or not (S104). The CCV_AAA is computed using Equation 1, and its description is omitted.

That is, since the CCV_PSS computed in the PSS 200 is identical to the CCV_AAA computed in the AAA server 230 if the PSS 200 and the AAA server 230 have the same master key, the AAA server 230 computes the CCV_AAA using the master key M1′ retained therein and the same input values of the hash function in order to verify the CCV_PSS of the PSS 200.

Then, it is determined whether the CCV_PSS of the PSS 200 is identical to the CCV_AAA of the AAA server 230 or not, that is, whether the master key M1 of the PSS 200 is identical to the master key M1 of the AAA server 230 or not (S106).

If the CCV_PSS of the PSS 200 is identical to the CCV_AAA of the AAA server 230, that is, the master key M1 of the PSS 200 is identical to the master key M1′ of the AAA server 230, the AAA server 230 determines that the corresponding PSS 200 is an original PSS and makes the authentication method which does not require an input of the password selected during the SBC negotiation procedure (S108). Accordingly, the authentication method which does not require an input of the password (e.g., USIM-based EAP-AKA authentication method) is performed for the corresponding PSS 200 (s110).

When the corresponding PSS 200 succeeds in authentication, the AAA server 230 updates the master key retained therein and transmits the updated master key to the PSS (S112 to S114).

Thus, when the authentication procedure and the master key updating procedure are completed, access of the PSS to the network is allowed (S116).

If the CCV_PSS of the PSS 200 is not identical to the CCV_AAA of the AAA server 230, that is, the master key M1 of the PSS 200 is not identical to the master key M1′ of the AAA server 230, the AAA server 230 determines that the corresponding PSS 200 is illegally a duplicated PSS and makes the authentication method which requires an input of the password (e.g., EAP-MD5) selected during the SBC negotiation procedure (S118). Accordingly, the authentication method which requires an input of the password is performed for the corresponding PSS 200 (S120).

Next, it is determined whether the PSS 200 which is doubted as duplicated previously succeeded in the password authentication or not (S122). When the PSS 200 has previously succeeded in the password authentication, the AAA server 230 determines whether the duplication possibility bit value is “1” or not in order to confirm whether the corresponding PSS 200 previously succeeded in the password authentication or not (S124).

Here, the duplication possibility bit value checks a duplication possibility of the PSS, and it is set to “0” when there is no case where the corresponding PSS is determined to be duplicated, i.e., there is no duplication possibility, and to “1” when the PSS which is doubted as illegally duplicated succeeds in the password authentication.

That is, in a case where the PSS is duplicated by the user's own volition, if the PSS 200 succeeds in the password authentication, the PSS 200 can access the network. However, if the duplicated PSS continuously tries to access the network, the duplication possibility bit value is checked, and its duplication possibility bit value is set to “1”, it is determined that there is a high possibility that the PSS is illegally duplicated. Thus, even though the corresponding PSS succeeds in the password authentication, access of the PSS to the network is rejected.

If the duplication possibility bit value is “0”, that is, there is no case where the corresponding PSS is previously determined to be illegally duplicated, the AAA server 230 sets the duplication possibility bit value to “1” in order to indicate that there is a possibility that the corresponding PSS is duplicated (S126), and updates the master key for the corresponding PSS and transmits it to the PSS 200 through the RAS 210.

If the duplication possibility bit value is “1”, that is, it is determined that the corresponding PSS has previously succeeded in the password authentication, the AAA server 230 determines that the corresponding PSS 200 is illegally duplicated by the user's own volition since a person who knows the password is only the user (S128), and rejects access of the corresponding PSS 200 to the network while reporting it to the network operator (S130).

Meanwhile, if the PSS 200 which is doubted as illegally duplicated fails in the password authentication, the AAA server 230 determines that the corresponding PSS 200 is maliciously duplicated by a third party (S132), and it rejects access of the corresponding PSS 200 to the network while reporting it to the network operator (S130).

As described above, according to the PSS duplication detecting step P, even though the duplicated PSS stores all information including the MAC address, the master key, the A-key, and the call history count of the original PSS, if one of the original PSS or the duplicated PSS succeeds in authentication, the AAA server 230 updates the master key, and if the other requests authentication using the previous master key, the AAA server 230 recognizes that there is a difference between the master keys and doubts that the PSS of the corresponding MAC address is illegally duplicated.

In addition, since the user is asked to input the password for the PSS which is doubted as duplicated, it is possible to find out whether the PSS 200 is illegally duplicated by the user's own volition or by the malicious third party.

Referring again to FIG. 14, if it is determined that the PSS 200 is determined to be legitimate and so access of the PSS 200 to the network is allowed, a traffic encryption key for encrypting traffic data is generated and distributed to the PSS 200 (S914).

When the procedure for generating and distributing the traffic encryption key is completed, the RAS 210 negotiates functions related to the MAC layer of the PSS to register a device address of the PSS 200 (S916).

Next, the RAS 210 allocates an IP address to the PSS 200 through a DHCP server or an MIP server to setup an IP connection (S918).

A traffic connection is setup for the PSS 200 which is allocated the IP address so that the PSS 200 can be provided with a traffic service (S920).

One example of an apparatus for detecting illegal duplication of the PSS in the portable Internet system according to the exemplary embodiment of the present invention is described below.

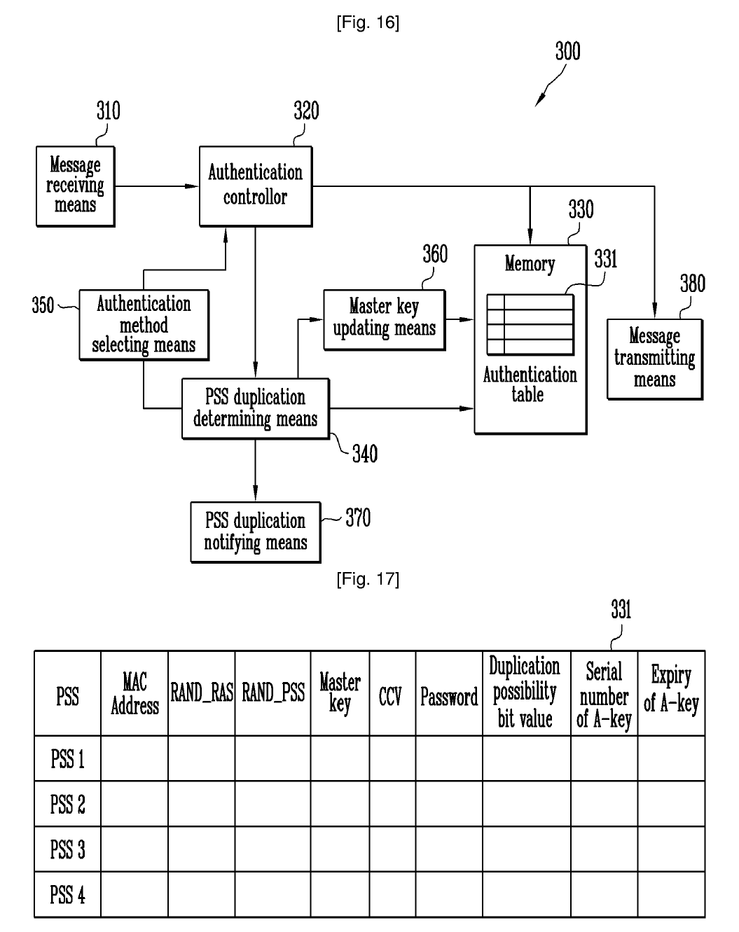

FIG. 16 is a block diagram illustrating an apparatus for detecting illegal duplication of the PSS in the portable Internet system according to the exemplary embodiment of the present invention.

As shown in FIG. 16, the PSS duplication detecting apparatus 300 comprises a message receiving means 310 for receiving messages from the RAS 210 or the ACR 220, an authentication controller for analyzing information contained in the message received by the message receiving means 310 to control the whole operation related to authentication and duplication determination for the PSS 200, a memory 330 having an authentication table 331 for storing various information necessary for authentication and duplication determination of the PSS 200, a PSS duplication determining means 340 for determining whether the PSS 200 is duplicated or not based on information recorded in the authentication table 331 of the memory 330, an authentication method selecting means 350 for selecting the authentication method with the PSS according to the determination result as to whether the PSS 200 is duplicated or not, a master key updating means 360 for updating the master key whenever the PSS 200 succeeds in authentication, a PSS duplication notifying means 370 for notifying the fact that the PSS 200 is duplicated according to the duplication determination result of the PSS duplication determining means 340, and a message transmitting means 380 for transmitting messages to the RAS 210 and the ACR 220.

The PSS duplication detecting apparatus 300 is preferably arranged in the AAA server 230 which follows IEEE 802.16 standard shown in FIG. 2. If the PSS duplication detecting apparatus 300 is arranged in the AAA server 230, parts which perform the same function can be omitted to simplify its configuration.

The message receiving and transmitting means 310 and 380 are to receive/transmit messages from/to the RAS 210 and the ACR 220 and are identical in configuration to those used in the typical portable Internet system, and thus description thereof is omitted.

The authentication controller 320 analyzes information contained in the message received by the message receiving means 310 to control the whole operation related to authentication and duplication determination of the PSS 200.

The memory 330 has the authentication table 331 in which information necessary for authentication and duplication determination of the PSS 200 is stored.

FIG. 17 shows the authentication table of the memory according to the exemplary embodiment of the present invention.

As shown in FIG. 17, the authentication table 331 stores at least one of the RAND_RAS, the RAND_PSS, the MAC address of the PSS, the CCV_PSS, the master key of the AAA server, the password, the duplication possibility bit value, the CCV_AAA, a serial number of the authentication key, and expiry information of the authentication key. A function of the duplication possibility bit value has already been described above with reference to FIG. 10, and thus description thereof is omitted.

Referring again to FIG. 16, the PSS duplication determining means 340 is to determine whether the PSS is duplicated or not based on information recorded in the authentication table 331 of the memory 330, and an operation of the PSS duplication determining means 340 will be described in detail later.

The authentication method selecting means 350 selects the authentication method with the PSS according to the determination result of the PSS duplication determining means 340. It selects the authentication method which does not require an input of the password during the SBC negotiation procedure if the corresponding PSS 200 is determined to be legitimate, and selects the authentication method which requires an input of the password during the SBC negotiation procedure if the corresponding PSS 200 is determined to be illegally duplicated.

The master key updating means 360 updates the master key recorded in the authentication table 331 of the memory 330 key when the PSS 200 succeeds in authentication according to the authentication method selected by the authentication method selecting means 350, and transmits the updated master key to the PSS 200 through the message transmitting means 380.

The PSS duplication notifying means 370 notifies a network operator of the fact that the PSS 200 is determined to be duplicated by the PSS duplication determining means 340. At this time, the network operator is also notified whether duplication is made by the users own volition or by the malicious third party.

Hereinafter, an operation of the PSS duplication detecting apparatus 300 of when it is arranged in the AAA server 230 will be described in detail.

First, the message receiving means 310 receives the PCP-REQ-AA message from the RAS 210, and the authentication controller 320 analyzes the PCP-REQ-AA message to store the RAND_RAS, the RAND_PSS, the MAC address of the PSS 200, and the CCV_PSS of the PSS 200, which are contained in the PCP-REQ-AA message, in the authentication table 331 of the memory 330.

The PSS duplication determining means 340 inputs the RAND_RAS, the RAND_PSS, the master key M1, and the MAC address of the PSS 200 recorded in the authentication table 331 of the memory 330 to the hash function to compute the CCV_AAA of the AAA server 230. The CCV_AAA computing method using Equation 1 has already been described above, and thus description thereof is omitted.

The PSS duplication determining means 340 compares the CCV_PSS of the PSS 200 and the CCV_AAA of the AAA server 230 to find out whether the CCV_PSS is identical to the CCV_AAA or not.

That is, the PSS duplication determining means 340 determines whether the master key M1 of the PSS 200 is identical to the master key M1′ of the AAA server 230 or not.

If the CCV_PSS of the PSS 200 is identical to the CCV_AAA of the AAA server 230, that is, the master key M1 of the PSS 200 is identical to the master key M1 of the AAA server 230, the PSS duplication determining means 340 determines that the corresponding PSS 200 is an original PSS.

However, if the CCV_PSS of the PSS 200 is not identical to the CCV_AAA of the AAA server 230, that is, the master key M1 of the PSS 200 is not identical to the master key M1′ of the AAA server 230, the PSS duplication determining means 340 determines that the corresponding PSS 200 is illegally duplicated.

The authentication method selecting means 350 selects the authentication method which does not require an input of the password during the SBC negotiation procedure if the corresponding PSS 200 is determined to be legitimate.

If the authentication controller 320 performs the authentication method which does not require an input of the password and the PSS 200 succeeds in the authentication, the master key updating means 360 updates the master key of the authentication table 331.

The updated master key is transmitted to the PSS 200 through the message transmitting means 380, so that the master key of the PSS 200 is also updated.

However, the authentication method selecting means 350 selects the authentication method which requires an input of the password during the SBC negotiation procedure if the corresponding PSS 200 is determined to be illegally duplicated. The authentication controller performs the authentication method which requires an input of the password.

If the duplicated PSS succeeds in the password authentication, the PSS duplication determining means 340 checks whether the duplication possibility bit value is “1” or not in the authentication table 331 in order to check whether the corresponding PSS previously succeeded in the password authentication or not.

If the duplication possibility bit value is “0”, that is, there is no case where the corresponding PSS is determined to be illegally duplicated, the PSS duplication determining means 340 sets the publication possibility bit value of the corresponding PSS to “1” to indicate that there is a possibility that the corresponding PSS can be duplicated, and records it in the authentication table 331.

The master key updating means 360 updates the master key for the corresponding PSS and transmits it to the corresponding PSS through the message transmitting means 380 so that the master key of the PSS 200 can be updated.

If the duplication possibility bit value is “1”, that is, it is determined that the corresponding PSS previously succeeded in the password authentication, the PSS duplication determining means 340 determines that the corresponding PSS 200 is illegally duplicated by the user's own volition since a person who knows the password is only the user, and thus it rejects access of the corresponding PSS to the network and reports to the network operator the fact that the corresponding PSS is duplicated.

If the PSS 200 which is doubted as illegally duplicated fails in the password authentication, the PSS duplication determining means 340 determines that the corresponding PSS 200 is maliciously duplicated by a third party and rejects access of the corresponding PSS 200 to the network while reporting it to the network operator.

As described above, according to the PSS duplication detecting apparatus of the present invention, since the master keys of the PSS 200 and the AAA server 230 are simultaneously updated whenever the PSS 200 succeeds in authentication, it is possible to check whether the corresponding PSS is a duplicated PSS or not by comparing the master key of the PSS 200 to the master key of the AAA server 230.

Also, according to the PSS duplication detecting apparatus of the present invention, it is possible to check whether the PSS is illegally duplicated by the user or the malicious third party since the authentication procedure which requires the user of the PSS which is doubted as duplicated to input the password is additionally performed.

The exemplary embodiment of the present invention can be realized by a computer-executable program and can be implemented by a universal digital computer which executes the program using a computer readable recording medium.

While the invention has been shown and described with reference to certain exemplary embodiments thereof, it will be understood by those skilled in the art that various changes in form and details may be made therein without departing from the spirit and scope of the invention as defined by the appended claims.

1. A method for detecting duplication of a portable subscriber station (PSS) in a portable Internet system including an authentication authorization and accounting (AAA) server which performs authentication for the PSS and a radio access station (RAS) wirelessly connecting the PSS and the AAA server, the method comprising the steps of:
(a) performing a first authentication, at the AAA server, using a master key of a connected PSS;
(b) updating the master key of the connected PSS when the first authentication is successfully performed, and performing a second authentication using inherent information provided to an original PSS when the first authentication fails; and
(c) checking a duplication possibility bit value when the second authentication is successfully performed, authenticating the connected PSS as legitimate when there is no duplication possibility bit value and updating the master key of the connected PSS after assigning a duplication possibility bit value, and determining the connected PSS as duplicated when there is a duplication possibility bit value or the second authentication fails.

2. The method of claim 1, wherein in step (a), the first authentication is performed by comparing a first duplication confirmation value computed using the master key of the connected PSS with a second duplication confirmation value computed using a master key retained in the AAA server.

3. The method of claim 2, wherein the first duplication confirmation value is computed using the master key of the connected PSS and at least one of a random number generated in the RAS, a random number generated in the connected PSS and a MAC address of the connected PSS, and the second duplication confirmation value is computed using the master key of the AAA and at least one of the random number generated in the RAS, the random number generated in the connected PSS and the MAC address of the connected PSS.

4. The method of claim 1, wherein in step (a), the master key is a first master key assigned by the AAA server or an updated master key.

5. The method of claim 4, wherein the first master key is a master key assigned by the AAA server when authentication for the original PSS is performed for the first time, and the updated master key is a master key assigned by the AAA server whenever the first authentication or the second authentication is successfully performed.

6. The method of claim 1, wherein in step (a), the first authentication is performed using a USIM card-based EAP-AKA authentication method.

7. The method of claim 1, wherein in step (a), the PSS connected to the AAA server is an original PSS or a duplicated PSS which stores at least one of a MAC address, a master key, and a call count of the original PSS.

8. The method of claim 1, wherein in step (b), the second authentication is performed using an EAP-MD5 authentication method.

9. The method of claim 1, further comprising the step of, after step (c),
(d) rejecting access of the connected PSS to a network and reporting to a network operator the fact that the connected PSS is a duplicated PSS when the connected PSS is determined to be duplicated.

10. The method of claim 9, wherein in step (d), a duplication type is reported to the network operator such that it is determined that the connected PPS is duplicated by a user's own volition when there is the duplication possibility bit value, and it is determined that the connected PSS is duplicated by a third party when the second authentication fails.

11. The method of claim 1, wherein in steps (b) and (c), the master key is updated such that the AAA server generates a new master key and transmits the new master key to the connected PSS, so that a master key of the connected PSS is identical to a master key of the AAA server.

12. A method for detecting duplication of a portable subscriber station (PSS) in a portable Internet system including an AAA server which performs authentication, the PSS including an original PSS and a duplicated PSS which store information including a MAC address, a master key, and a call count of the original PSS, the method comprising the steps of:
(a) performing a first authentication, at the AAA server, using a master key of a connected PSS;
(b) updating the master key of the connected PSS and allowing access of the connected PSS to a network when the first authentication is successfully performed, and performing a second authentication using inherent information provided to an original PSS when the first authentication fails; and
(c) updating the master key of the connected PSS and allowing access of the connected PSS to the network when the second authentication is successfully performed, and determining the connected PSS as duplicated and rejecting access of the connected PSS to the network when the second authentication fails.

13. The method of claim 12, wherein in step (c), when the second authentication is successfully performed, a duplication possibility bit value is checked, the duplication possibility bit value is assigned when there is no duplication possibility bit value, and the master key of the connected PSS is updated, so that access of the connected PSS to the network is allowed; and even though the second authentication is successfully performed, when the duplication possibility bit value exists, the connected PSS is determined to be duplicated, so that access of the connected PSS to the network is rejected.

14. An apparatus for detecting duplication of a portable subscriber station (PSS) in a portable Internet system, comprising:
a memory including an authentication table for storing a master key and a duplication possibility bit value for each PSS;
a PSS duplication determining means for comparing the master key of the PSS connected through a radio access station (RAS) with the master key stored in the authentication table to determine whether the connected PSS is an original PSS or not, and determining whether the connected PSS is duplicated or not using the duplication possibility bit value stored in the authentication table;
a master key updating means for identically updating the master key of the connected PSS and the master key of the authentication table when the connected PSS is determined to be legitimate; and
an authentication controller for performing the whole operation related to authentication and duplication determination for the connected PSS.

15. The apparatus of claim 14, wherein the authentication table comprises the master key of the PSS, the duplication possibility bit value for the PSS, and information provided to an original PSS.

16. The apparatus of claim 14, wherein the authentication table comprises at least one of a random number generated in the RAS, a MAC address of the connected PSS, a random number generated in the connected PSS, a duplication confirmation value of the connected PSS, a duplication confirmation value computed in the PSS duplication determining means, a serial number of an authentication key, and expiry information of the authentication key.

17. The apparatus of claim 14, further comprising an authentication method selecting means for selecting an authentication method of the connected PSS according to the determination result of the PSS duplication determining means.

18. The apparatus of claim 17, wherein the authentication method selecting means, selects a first authentication method for authentication of the connected PSS when the connected PSS is determined to be legitimate by the PSS duplication determining means, and
selects a second authentication method which uses inherent information provided to the original PSS for authentication of the connected PSS when the connected PSS is determined to be duplicated by the PSS duplication determining means.

19. The apparatus of claim 14, wherein the PSS duplication determining means:
determines the connected PSS as legitimate by determining that the master key of the connected PSS is identical to the master key of the authentication table when the duplication confirmation value of the connected PSS is identical to the duplication confirmation value of the authentication table; and
determines the connected PSS as duplicated by determining that the master key of the connected PSS is not identical to the master key of the authentication table when the duplication confirmation value of the connected PSS is not identical to the duplication confirmation value of the authentication table.

20. The apparatus of claim 19, wherein the duplication confirmation value of the connected PSS is computed by a hash function which receives at least one of a random number generated in the RAS, a random number generated in the connected PSS, and a MAC address of the connected PSS in addition to the master key of the connected PSS as input values, and the duplication confirmation value of the authentication table is computed by a hash function which receives at least one of the random number generated in the RAS, the random number generated in the connected PSS, and the MAC address of the connected PSS in addition to the master key of the authentication table as input values.

21. The apparatus of claim 14, wherein the authentication controller performs the first authentication when the connected PSS is determined to be legitimate and performs the second authentication which uses inherent information provided to an original PSS when the connected PSS is determined to be duplicated.

22. The apparatus of claim 18, wherein the first authentication method is a USIM card-based EAP-AKA authentication method, and the second authentication method is an EAP-MD5 authentication method.

23. The apparatus of claim 21, wherein when the second authentication is successfully performed, the PSS duplication determining means checks the duplication possibility bit value of the connected PSS stored in the authentication table, determines the connected PSS as legitimate when the duplication possibility bit value does not exist, assigns the duplication possibility bit value, and stores the assigned duplication possibility bit value in the authentication table.

24. The apparatus of claim 21, wherein when the second authentication is successfully performed, the PSS duplication determining means checks the duplication possibility bit value of the connected PSS stored in the authentication table, and determines the connected PSS as duplicated when the duplication possibility bit value exists or the second authentication fails.

25. The apparatus of claim 21, wherein when the second authentication for the connected PSS is successfully performed, the PSS duplication determining means determines the connected PSS as duplicated by a user's own volition when the duplication possibility bit value of the authentication table exists, and when the second authentication for the connected PSS fails, the PSS duplication determining means determines the connected PSS as duplicated by a third party.

26. The apparatus of claim 14, further comprising a PSS duplication notifying means for notifying the fact that the connected PSS is duplicated according to the determination result of the PSS duplication determining means.
